(19) United States
(12) Patent Application Publication
(10) Pub. No.: US 2009/0062944 A1
(43) Pub. Date: Mar. 5, 2009

(54) Modifying media files

(75) Inventors: Policarpo Wood, Cupertino, CA (US); Alejandro O. Crovetto, San Jose, CA (US); William Bull, Mountain View, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/152,780

(22) Filed: May 16, 2008

Related U.S. Application Data
(60) Provisional application No. 60/967,546, filed on Sep. 4, 2007.

(51) Int. Cl. G06F 17/00

(52) U.S. Cl. 700/94

(57) ABSTRACT

The present invention includes apparatuses, methods, computer readable media and systems comprising means for using a portable, handheld electronic device (such as Apple's iPod™) to capture analog signals, convert them into digital signals and store the digital signals as media files (e.g., audio files, video files, image files, etc.). The electronic device can subsequently be used to modify the media files. The modifications can be virtual modifications, in which metadata is stored on the electronic device in a manner that does not alter the media file. The virtual modifications can be used by the electronic device to give the perception to the user that a media file has been actually modified. In addition, the virtual modifications can be used by an application running on a host device, such as a home computer or network server (like Apple's .MAC™ servers), to actually modify the digital media file.

### INCORPORATION BY REFERENCE OF RELATED APPLICATION

This application hereby claims the benefit of U.S. Provisional Patent Application No. 60/967,546, filed Sep. 4, 2007.

### FIELD OF THE INVENTION

The present invention relates to editing media (such as digital music, video and images) stored in media files. More particularly, this invention relates to computer readable media, methods, apparatuses and other means for creating, tagging and/or splitting media files with a handheld device.

### BACKGROUND OF THE INVENTION

Although the present invention can be used in conjunction with any type of media, for simplicity, this discussion often references audio recording and manipulation devices. Audio recording devices are well known and used for a wide range of applications. In commercial applications, record companies, movie producers, recording studios, and the like invest tens of thousands, even millions, of dollars in professional audio recording and editing equipment. Although expensive, professional equipment enables audio signals to be captured, created and modified. However, such equipment can be very complicated to use and is not intended or designed to be carried around or even used by individual consumers.

In addition to commercial equipment, recent developments in consumer technology enable users to manipulate and edit audio files using their desktop or laptop computer. For example, a home computer, which includes a microphone, storage device, and audio editing application (such as, e.g., Apple Inc.'s GarageBand™), can enable the user to capture, generate and edit audio signals. Although these systems allow consumers to create and interact with audio signals, there is a need for more portable, handheld devices to provide the same or similar capabilities as their larger, more powerful and expensive brethren.

Handheld electronic devices, like audio dictators and audio cassette players, have allowed consumers for decades to record audible sounds. More recently, consumers were introduced to handheld digital audio recorders. Digital audio recorders, like the earlier analog cassette-based recorders, are usually all-in-one devices and include, e.g., a microphone (and/or other transducer), a storage device, and a speaker for playback. These all-in-one handheld digital recording devices, however, generally have less processing power, memory and storage space than a consumer desktop computer (e.g., Apple Inc.'s MAC PRO™) or personal laptop computer (e.g., Apple Inc.'s MACBOOK™). The limitations of handheld devices often prevent the implementation of specialized or professional software applications on the handheld devices, or the simpler accessory devices that are used in conjunction with handheld devices. If a user wants to edit the audio signals that were recorded with a handheld device the user is forced to upload the audio file as recorded onto a non-handheld computer that has specialized software.

Accessory devices are also known that enable handheld devices, which are lacking one or more necessary components (e.g., a microphone), to record audio signals. For example, there are now accessory devices that capture analog audio signals, create audio files and store the audio files on a handheld portable device. Belkin Corporation's TuneTalk™, for example, is such an accessory device. The TuneTalk™ can be coupled to the 30-pin connector of an iPod™. (Apple Inc. owns the iPod™ trademark.) When coupled to an iPod™, since the TuneTalk™ does not have its own source of power or display screen, the TuneTalk™ relies on the power source and display screen of the iPod™. Since an iPod™ currently does not have a microphone, the TuneTalk™ includes a microphone and circuitry that captures sound and converts it into a digital audio file, which is stored in the iPod™'s storage device. When the iPod™ is subsequently coupled to a laptop or desktop computer, the digital audio file is uploaded from the iPod™ to the computer. The user can also use the iPod™ to listen to the audio file.

In addition, the TuneTalk™ is an excellent example of how the most recent advances in handheld technology are focused on improving the functionality and power usage of existing devices, but avoid, and in some instances exasperate other portability-related problems of handheld devices.

An example of such a problem occurs because many portable devices are now using solid-state memory, which is sometimes referred to herein as flash memory. Flash memory is great for handheld devices because it allows fast access to stored data, has no moving parts, and is light weight and compact. Flash memory, however, stores data in cells that are surrounded by an insulating oxide layer. Writing data to and erasing data from flash memory causes the insulating oxide layer to degrade. In other words, as data is added and deleted from flash memory, the lifespan of the flash memory decreases. If currently available devices that have flash memory were used to (1) record an audio file onto the flash memory, (2) access the audio file from the flash memory, and (3) edit and save the audio file to the flash memory, the flash memory would have to be written to at least twice and erased from at least once. Systems and methods are desired that minimize the degradation of flash memory, while still allowing the user to repeatedly use a flash memory device to, e.g., record and edit audio files, despite those functions requiring multiple writes and erasures to and from the flash memory.

### SUMMARY OF THE INVENTION

In accordance with the present invention, methods, apparatuses, computer readable media and other means for recording and modifying a media file using one or more electronic devices are discussed herein. An electronic device, such as an iPod™, can present an interactive menu display, having at least one option to a user. In response to the user selecting an editing option, the electronic device can generate a virtual modification that is associated with a media file (e.g., a song, picture or movie file). The editing option can be presented while the media file is still being created or added to by the electronic device. In some embodiments, the virtual modification can be automatically generated by the electronic device (as opposed to or in addition to in response to the editing option being selected). The media file can include, e.g., formatted digital signals that represent the analog signals received by a transducer coupled to or integrated into the electronic device. The digital signals can also be played back and/or presented as analog signals by the electronic device. The electronic device can store the virtual modification in a metadata modify file that is associated with the media file.

The electronic device can later access and retrieve data from the media file. After determining that a metadata modify file is associated with the media file, the electronic device can access the metadata modify file and retrieve metadata, including data that represents any virtual modifications that have been made. The media file can then be used to generate analog signals, which can be emitted by the electronic device (or any other device) to the user. While emitting or displaying analog signals, the electronic device can generate information using the metadata of the metadata modify file and present a display to the user, wherein the display includes the information.

A host device can be electrically coupled (wirelessly or otherwise) to the electronic device. The host device can be, for example, a home computer or network server. The electronic device can then transfer the media file and/or the metadata modify file to the host device. The host device can then store the media file and/or metadata modify file in its storage component. In addition, the host device can create a modified version of the media file by using any virtual modifications (it receives form the electronic device) to actually modify the media file. The modified media file can then be transferred to the electronic device.

In some embodiments, the metadata modify file can include media data, such as supplementary audio, video or image signals. The metadata modify file can also include metadata tags.

In some embodiments, the virtual modification can be associated with a particular type of dynamic metadata tag that causes the host device to generate and execute commands automatically. For example, when there is a virtual modification that includes a podcast identifier, the host device can automatically publish the media file to a website, such as a web blog.

The electronic device can make modifications to a media file while the media file is being presented or generated.

### SUMMARY OF THE FIGURES

The above and other features of the present invention, its nature and various advantages will be more apparent upon consideration of the following detailed description, taken in conjunction with the accompanying drawings, in which like reference characters refer to like parts throughout, and in which:

FIGS. 1 and 2 are illustrative systems that incorporate the present invention;

FIG. 3 is a simplified schematic block diagram of an illustrative embodiment of circuitry in accordance with the present invention;

FIGS. 4-12 are depictions of representative interactive user interface displays according to embodiments of the present invention;

FIGS. 13-15 are simplified logical flows of illustrative modes of operation of circuitry in accordance with embodiments of the present invention;

FIG. 16 is an illustrative embodiment of a metadata modify file structure; and

FIG. 17 is an illustrative embodiment of a media file structure.

### DETAILED DESCRIPTION

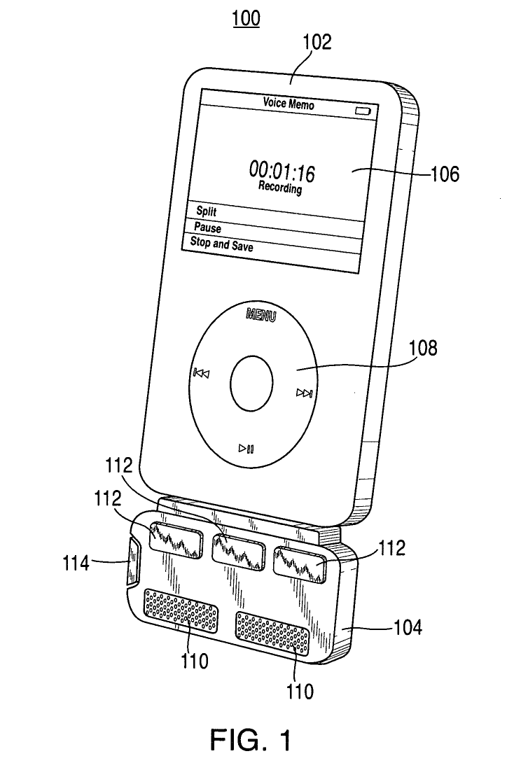

FIG. 1 shows a simplified diagram of computer system 100, which can be operated in accordance with the principles of the present invention. In some embodiments, computer system 100 includes handheld device 102 and accessory device 104. Handheld device 102 is shown as including display component 106 and user input component 108.

Display component 106 is illustrated in FIG. 1 as a display screen that is integrated into handheld device 102. Display component 106, like any other component discussed herein, does not have to be integrated into handheld device 102 and can be external to handheld device 102. For example, display component 106 can be a computer monitor, television screen, and/or any other graphical user interface, textual user interface, or combination thereof. Display component 106 enables handheld device 102 to playback the video portion of video content, and/or may serve as part of the user interface (by displaying user interface displays), etc.

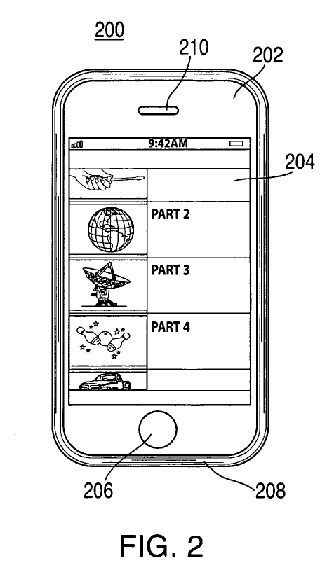

User input component 108 is illustrated in FIG. 1 as a click wheel. One skilled in the art would appreciate that user input component 108 could be any type of user input device that is integrated into or located external to handheld device 102. For example, user input component 108 could also be a mouse, keyboard, trackball, slider bar, one or more buttons, electronic device pad, dial, or any combination thereof. User input component 108 may also include a multi-touch screen such as that shown in FIG. 2 and described in commonly assigned Westerman et al., U.S. Pat. No. 6,323,846, issued Nov. 27, 2001, entitled “Method and Apparatus for Integrating Manual Input,” which is incorporated by reference herein in its entirety. User input component 108 may emulate a rotary phone or a multi-button electronic device pad, which may be implemented on a touch screen or the combination of a click wheel or other user input device and a screen. A more detailed discussion of such a rotary phone interface may be found, for example, in McKillop et al., U.S. patent application Ser. No. 11/591,752, filed Nov. 1, 2006, entitled “Touch Pad with Symbols based on Mode,” which is incorporated by reference herein in its entirety.

Accessory device 104 can include microphones 110, input buttons 112 and eject button 114. Microphones 110 can receive analog audio signals. Circuitry (which is discussed below) can be included in handheld device 102 and/or accessory device 104 and can convert the analog audio signals into one or more digital audio files. Buttons 112 can be used to interact with (e.g., edit, save, export, delete, etc.) the audio files. Eject button 114 can be used to decouple accessory device 104 from handheld device 102.

Accessory device 104 is shown in FIG. 1 as being physically and electrically coupled to handheld device 102 via a connector component (not shown). In other embodiments, accessory device 104 can be electrically coupled to handheld device 102 wirelessly and/or via any other type of physical connector component. When accessory device 104 is coupled to handheld device 102, either or both devices can have enhanced functionality. This enhanced functionality can automatically occur after successfully executing the proper handshaking protocols, in response to the devices being coupled together or in response to a user input. For example, accessory device 104 may not have its own power supply or display screen and only function when it is coupled to handheld device 102. Similarly, handheld device 102 may not have its own microphone(s) or have a lower fidelity microphone, but, when handheld device 102 is coupled to accessory device 104, the circuitry in handheld device 102 can use the microphone(s) of accessory device 104 to make high fidelity recordings. As another example, specialized circuitry or applications (for, e.g., recording and converting audio signals into digital data) can only be included in accessory device 104 and not in handheld device 102. Accessory device 104 can also have, for example, limited storage capacity and utilize the storage component(s) of handheld device 102 to store, among other things, audio files.

FIG. 2 shows computer system 200 which can also be used in accordance with the present invention. Computer system 200 includes electrical device 202, which can be, for example, a portable media player, cellular telephone, personal organizer, hybrid of such devices, or any other electrical device. Electrical device 202 comprises user interface component 204. User interface component 204 is shown in FIG. 2 as a multi-touch screen that can function as both an integrated display screen and user input device. Multi-touch display screens are discussed in more detail in commonly assigned U.S. Patent Publication No. U.S. 2006 0097991, entitled “MULTIPOINT TOUCHSCREEN,” which is incorporated herein by reference in its entirely. Electrical device 202 can also include one or more other user interface components, such as button 206, which can be used to supplement user interface component 204.

Microphone 208 and audio output 210 are respective examples of input and output components that can be integrated into electrical device 202. Microphone 208 may function similar to or the same as microphones 110 discussed above. As such, the audio recording functionality, components of accessory device 104 of FIG. 1 can be integrated into electrical device 202. Audio output 210 is shown as being a speaker integrated into electrical device 202, but one skilled in the art would appreciate that audio output 210 may also comprise an external device (such as headphones) or connector(s) used to facilitate the playing back of audio content and/or the audio portion of video content.

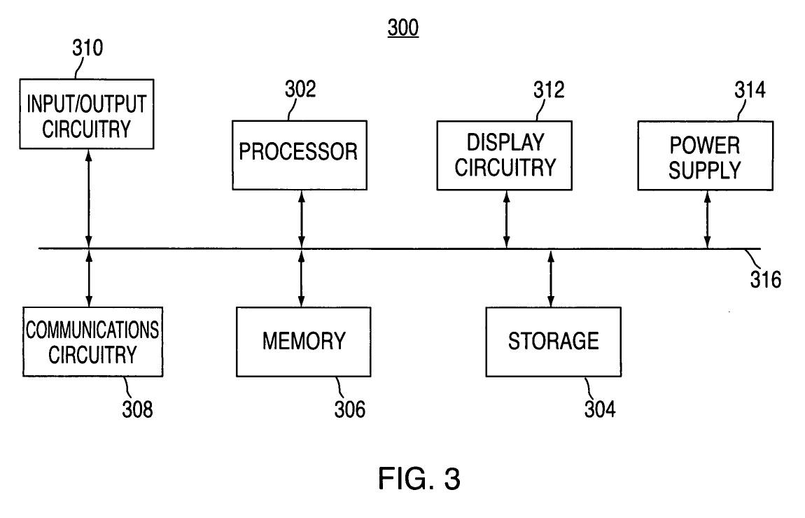

FIG. 3 illustrates a simplified schematic diagram of an illustrative electronic device or devices in accordance with some embodiments of the present invention. Electrical device 300 can be implemented in any type of electronic device or devices, such as, for example, handheld devices 102 and electrical device 202 discussed above.

Electrical device 300 can include control processor 302, storage 304, memory 306, communications circuitry 308, input/output circuitry 310, display circuitry 312 and/or power supply circuitry 314. In some embodiments, electrical device 300 can include more than one of each component, but for sake of simplicity, only one of each is shown in FIG. 3. In addition, one skilled in the art would appreciate that the functionality of certain components and circuitry can be combined or omitted and that additional components and circuitry, which are not shown in FIGS. 1-3, can be included in handheld device 102, accessory device 104, and/or electrical devices 202 and 300.

Processor 302 can include, for example, circuitry for and be configured to perform any function. Processor 302 may be used to run operating system applications, firmware applications, media playback applications, media editing applications, and/or any other application implemented on electrical device 300.

Storage 304 can be, for example, one or more storage mediums, including for example, a hard-drive, flash memory, other non-volatile memory (e.g., ROM), any other suitable type of storage component, or any combination thereof. Storage 304 may store, for example, media data (as, e.g., music, image and video files), application data (for, e.g., implementing functions on device 200), firmware, user preference information data (e.g., media playback preferences), lifestyle information data (e.g., food preferences), exercise information data (e.g., information obtained by exercise monitoring equipment), transaction information data (e.g., information such as credit card information), wireless connection information data (e.g., information that may enable electrical device 300 to establish a wireless connection), subscription information data (e.g., information that keeps track of podcasts or television shows or other media a user subscribes to), contact information data (e.g., telephone numbers and email addresses), calendar information data, any other suitable data, or any combination thereof.

Memory 306 can include cache memory, semi-permanent memory such as RAM, and/or one or more different types of memory used for temporarily storing data. Memory 306 can also be used for storing data used to operate electronic device applications.

Communications circuitry 308 can permit device 300 to communicate with one or more servers or other devices using any suitable communications protocol. For example, communications circuitry 308 may support Wi-Fi (e.g., a 802.11 protocol), Ethernet, Bluetooth™ (which is a trademark owned by Bluetooth Sig, Inc.), high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof.

Input/output circuitry 310 can convert as well as encode/decode, if necessary, analog signals and other signals (e.g., physical contact inputs (sometimes called touch events, from e.g., a multi-touch screen), physical movements (from, e.g., a mouse), analog audio signals, etc.) into digital data. Input/output circuitry 310 can also convert digital data into any other type of signal. The digital data can be provided to and received from processor 302, storage 304, memory 306, or any other component of electrical device 300. Although input/output circuitry 310 is illustrated in FIG. 3 as a single component of electrical device 300, a plurality of input/output circuitry can be included in electrical device 300. Input/output circuitry 310 can be used to interface with any input or output component, such as those discussed in connection with FIGS. 1 and 2. For example, electrical device 300 can include specialized input circuitry associated with, e.g., one or more microphones, cameras, proximity sensors, accelerometers, ambient light detectors, etc. Electrical device 300 can also include specialized output circuitry associated with output devices such as, for example, one or more speakers, etc.

Display circuitry 312 is an example of a specific type of output circuitry. Display circuitry 312 can accept and/or generate data signals for presenting media information (textual and/or graphical) on a display screen. Some examples of displays that can be generated by display circuitry 312 are discussed below. Display circuitry 312 can include, for example, a coder/decoder (CODEC) to convert digital media data into analog signals. Display circuitry 312 also can include display driver circuitry and/or any other circuitry for driving a display screen. The display signals can be generated by, for example, processor 302 and/or display circuitry 312. In some embodiments, display circuitry 312, like any other component discussed herein, can be integrated into and/or external to electrical device 300.

Power supply 314 can provide power to the components of device 300. In some embodiments, power supply 314 can be coupled to a power grid (e.g., a wall outlet or automobile cigarette lighter). In some embodiments, power supply 314 can include one or more batteries for providing power to a portable electronic device. As another example, power supply 314 can be configured to generate power in a portable electronic device from a natural source (e.g., solar power using solar cells).

Bus 316 can provide a data transfer path for transferring data to, from, and/or among control processor 302, storage 304, memory 306, communications circuitry 308, and any other component included in electronic device. Although bus 316 is shown as a single line in FIG. 3 to avoid unnecessarily overcomplicating the drawing, one skilled in the art would appreciate that bus 316 may comprise any number and type(s) of data paths.

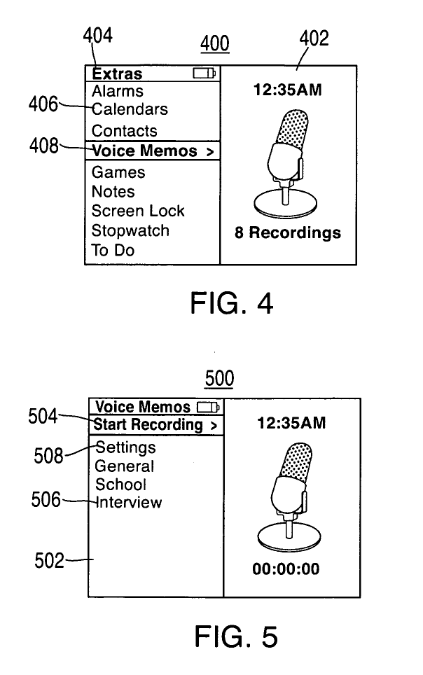

FIGS. 4-12 are depictions of representative interactive user interface displays according to embodiments of the invention. More specifically, a processor (and/or other circuitry) can be configured to present the interactive user interface displays of FIGS. 4-12 on a display screen or other user interface component. It is important to note that the displays shown in FIGS. 4-12 have been engineered and designed to be optimized for providing advanced interactive functionality, despite the limitations of relatively simple user input component or device, such as a click wheel or six button remote control. Simple user input devices, though easy for users to use, limit how a user can navigate within a display and among multiple displays. Designing interactive displays that are used in conjunction with these types of intuitive and simple, but limited, user input devices is generally a more complicated process than designing displays that are used with other, more intricate user input devices (such as a mouse, and keyboard combination, cellular telephone keypad, standard remote control that often has 12 or more buttons, etc.).

FIG. 4 shows display 400, which may be generated by, e.g., processor 302 and/or display circuitry 312. Display 400 can be displayed on, e.g., display component 106 or user interface 204. Like any display discussed herein, an electronic device can present display 400 in response to, for example, receiving a user selection of an option included in a main menu display (not shown), the user selecting an input button (virtual or physical) dedicated to display 400, the electronic device being powered ON, an accessory device (such as, e.g., accessory device 104) being coupled to the electronic device, receiving a signal from a remote device (not shown), and/or any other stimuli.

Display 400 can be subdivided into one or more regions, such as, for example, information region 402, header region 404 and options region 406. One skilled in the art would appreciate that the displays shown herein are merely illustrative examples and that more or less than three regions could be included in any display presented by an electronic device without departing from the spirit of the present invention.

Information region 402 can include, for example, various information derived from metadata bits stored in memory and/or on the storage device. In some embodiments, animated and/or static icons can also be included in information region 402.

Header region 404 can include a title or other information that helps the user understand the relative relationship between display 400 and other displays provided by the electronic device. Header region 404 is shown in FIG. 4 as simply including a display title, but, in other embodiments, header region 404 could also include, for example, a graphical file manager, tree structure, back button, delete button, etc.

Options region 406 is shown as including a vertical list of options that may be selected by a user. One skilled in the art would appreciate that the options could be arranged and grouped in any manner, including a vertical list or a two-dimensional table. As the user navigates through the list of options, information region 402 can be updated automatically. For example, options region 406 is shown with voice memos option 408 highlighted and corresponding information (e.g., icon and number of voice recordings) being presented in information region 402.

In response to the user selecting voice memos option 408, the electronic device can present, for example, display 500 of FIG. 5. As shown in options region 502 of display 500, a number of options can be provided to the user that are associated with voice memos option 408. For example, interview option 506, settings option 508, a general option, and a school option are shown as being included in region 502. In response to a user selecting settings option 508, the electronic device can present a display that enables the user to configure audio recording parameters. The general option, the school option and interview option 506 can each be associated with, for example, a predetermined set of parameters for making general audio recordings, audio recordings in a school, and during an interview, respectively. In other embodiments, one or more of the general option, school option and interview option 506 can refer to, not predetermined settings for making audio recordings, but rather lists of previously made audio recordings. In other words, the options included in options region 401 can be related to categories of recordings.

Also included in options region 502 is start recording option 504 that, in response to being selected, can cause the electronic device (and/or its accessory device) to start capturing analog audio signals. The electronic device (and/or its accessory device) can then convert the captured audio signals into a corresponding audio file, which can in turn be: saved to memory, saved to storage, outputted to a remote device, etc.

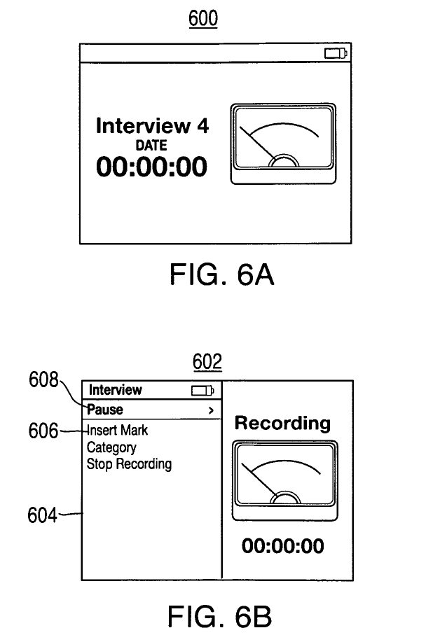

FIGS. 6A and 6B show displays 600 and 602, respectively, which are examples of displays that can be presented in response to the user selecting start recording option 504 included in options region 502. Display 600 includes various information (such as, e.g., title, date, volume/amplitude indicator, timer, etc.) related to, for example, the audio recording that is taking place. Display 600 can include both dynamic information (such as recording input amplitude/volume indicator and timer) and static information (e.g., title and date).

In other embodiments, display 602 can be presented to the user while the electronic device is recording audio signals. In addition to the regions included in display 600, display 602 includes option region 604. Options region 604 can include options that are associated with commands the user can initiate while the electronic device is recording.

For example, options region 604 can include various types of options, such as control options (e.g., pause and stop options), organizational options (e.g., category option), and editing options (e.g., insert mark option 606, an insert split option (not shown), etc.). Control options can allow the user to control the functionality (such as the recording functionality) of the electronic device. Organizational options enable the user to, for example, group, sort, access and otherwise organize data and information using the electronic device. Although display 602 is shown as being provided while the electronic device is recording audio signals, one skilled in the art would appreciate that additional editing displays, similar to or the same as display 602, could also be provided that allow the user to edit previously recorded audio signals (e.g., while playing back the audio signal, etc.).

Editing options presented in accordance with the present invention can enable the user to actually and/or virtually modify the audio file. The user can modify the audio file while recording audio signals or after the audio signals have been recorded (e.g., while in a play back mode, while in a dedicated editing mode, etc.). For example, in response to receiving an indication that the user has selected an editing option, the electronic device can edit the audio file accordingly or generate metadata that will cause a host device to edit the audio file later (e.g., when the metadata is uploaded to the host device). That is, while recording audio signals and/or in response to the user selecting insert mark option 606 included in options region 604, the electronic device can mark or otherwise modify the audio file, causing the audio file or an associated metadata modify file to be modified or generated. The metadata modify file, as discussed below, can be saved to storage and include at least one modify type field (e.g., a split mark, a join mark, a flag mark, a delete mark, etc.), and timestamp(s).

The metadata modify field can also be, for example, integrated into the audio file. In other embodiments, the metadata modify field is kept separate from other metadata associated with the audio file. This can be advantageous when the metadata modify field includes dynamic metadata rather than static metadata. Unlike static metadata, dynamic metadata can cause an application to execute a series of automatic commands (e.g., modify the associated audio media file, upload the associated audio media file to a network server, prompt the user for instructions, etc.). In these embodiments, the metadata modify field is separately stored in a metadata modify file that is associated with the audio file.

Despite the limitations of a click wheel or six-button input interface, the traditional method of highlighting an option and depressing a select button (such as the center button of user input component 108) would still be available to the user. In addition, display 602 would still allow one or more of the selectable options to have a dedicated button, even on relatively simple input components. For example, in some embodiments, the electronic device may interpret a depression of the bottom portion of user input component 108 (the play/pause portion) to indicate a user selection of pause option 608—regardless of what option is highlighted in display 600. Similarly, the left or right portion of user input component 108 could provide the same functionality as highlighting and selecting insert mark option 606. One skilled in the art would appreciate that when an accessory device, such as accessory device 112, is used in conjunction with the electronic device, buttons 112 can have a dedicated function for the application actively running on accessory device 112.

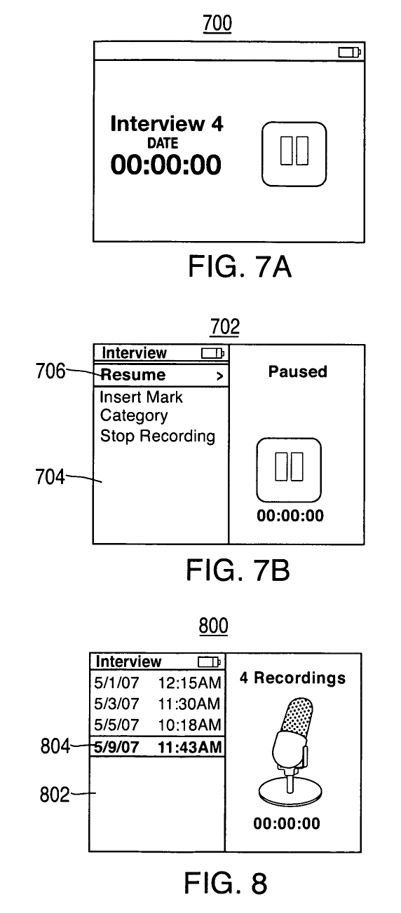

FIGS. 7A and 7B show displays 700 and 702, respectively, which are examples of displays that can be presented in response to the electronic device receiving a user input indicating the user's desire to pause the recording. The user can indicate a desire to resume recording by selecting, e.g., a dedicated button on a user input device. When display 702 is presented to the user, the user can also highlight and select resume option 706 included in options region 704.

In response to the user indicating a desire to go back (e.g., by depressing a back button or the top portion of user input component 108), the electronic device may return to display 500. The electronic device may continue functioning (e.g., recording, etc.) as it was, when it received the user indication to go back. In other embodiments, the go back command can automatically cause the electronic device to function differently (e.g., pause or stop recording). Regardless of how the electronic device is functioning, the user can select any of the options included in options region 502 after going back.

For example, the user can select interview option 506. In response, the electronic device can present display 800 of FIG. 8. Display 800 can include options region 802, which includes a listing of options. Each option in options region 802 is associated with an audio file that is stored in the memory and/or storage of the electronic device. The audio files could have been generated by the electronic device (either by itself or with the assistance of one or more accessory devices) and/or downloaded from another device. The audio files may each consists of one part or multiple parts.

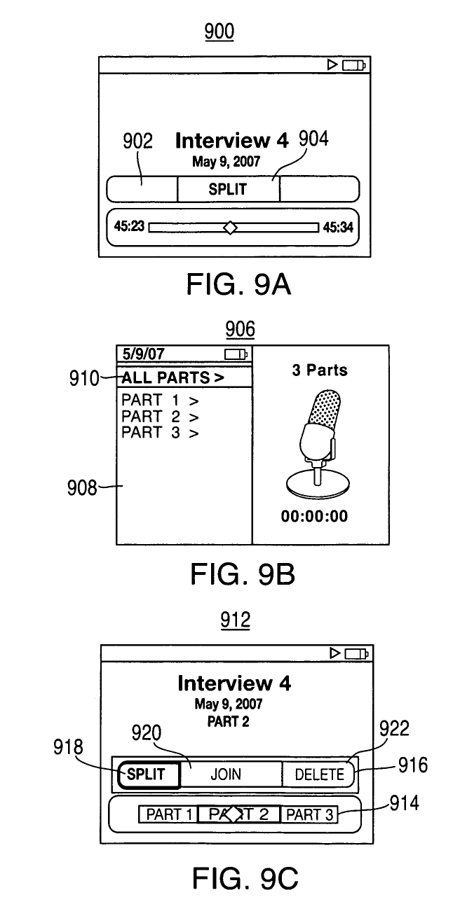

FIG. 9A includes display 900, which the electronic device can present in response to the user selecting to play an audio file that comprises only one part. For example, the recording made on May 9, 2007 may only consist of one part. The electronic device can access that one part audio file and present audio playback display 900 as shown in FIG. 9A. Display 900 can be presented in response to the user selecting May 9, 2007 recording option 804. The user can then listen to and modify (e.g., split, mark, etc.) the audio file. Whether or not the electronic device includes modification options area 902 may be dependent on whether or not the audio file being played can be modified. For example, because the May 9, 2007 audio file can be split, the electronic device presents split option 904 to the user.

FIG. 9B includes display 906, which can be displayed when the user selects to play an audio file that comprises more than one part. FIG. 9B is similar to a display that can be presented when the user selects to listen to a multipart audio book file. The recording made on May 9, 2007 may include, for example, three parts. Display 906 is shown as including options region 908, which includes all parts option 910 as well as other options dedicated to playing each part individually. In response to the user selecting an option associated with a particular part, the electronic device can present a display similar to or the same as display 900, wherein only the particular part is played back for the user. In addition, the user can select all parts option 910 and, in response, the electronic device can present display 912 of FIG. 9C. In other embodiments, display 906 can be omitted and display 912 can be displayed in response to the user selecting May 9, 2007 recording option 804.

Media bar 914 of display 912 indicates that the currently playing audio file has three parts. Modification options area 916 can be displayed when the currently playing audio file can be manually modified while it is being played back for the user. Modification options area 916 can include, for example, split option 918, join option 920 and delete option 922. Split option 918 can be used to split the audio file (again), which would, e.g., divide the May 9, 2007 audio file into 4 parts. Join option 920 could be used to combine two parts together, and remove a split in some embodiments. Delete option 922 can be used to delete the audio data associated with a part of the audio file. Other options could also be presented to the user (such as, e.g., cut, paste, move, etc.).

In some embodiments, as discussed in more detail below, the modifications made to an audio file can be virtual modifications (as opposed to actual modifications). Virtual modifications do not actually modify the audio file, but rather modify a separate metadata modify file. Virtual modifications, such as virtual splits, can enable the electronic device to make a single, one part audio file appear and act like separate audio files and/or one multipart file. The electronic device can access the metadata modify file when necessary to present the displays and implement the functionality discussed herein. The virtual modification approach provides a number of technical advantages, especially when implemented on a portable device that has limited processing capacity and battery power. For example, maintaining an actual file system by making actual modifications (as opposed to virtual modifications) requires a relatively substantial amount of possessing to relatively large amounts of data, which in turn uses relatively large amounts of battery power. The virtual modification approach taught herein allows the user to easily navigate a virtual multipart media file without actually creating a multipart file.

The teachings of the present invention also allow a more powerful host device to execute the processing intensive operations, such as modifying an audio file. For example, when the audio file and metadata modify file are uploaded from the portable electronic device to the host device, the user can be prompted as to whether or not the virtual modifications should be converted into actual modifications of the audio file. In other embodiments, the virtual modifications can be automatically converted by the host device into actual modifications. The modified audio file can then be uploaded from the host device and downloaded onto the portable electronic device.

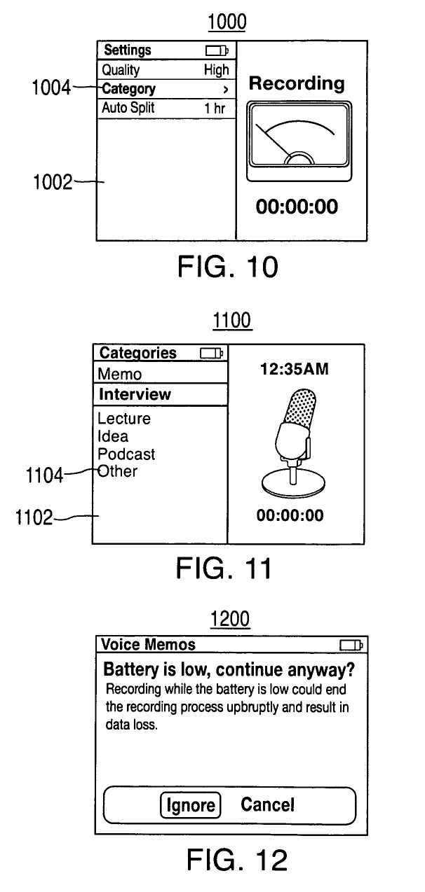

Returning to display 500 of FIG. 5, the user can also select settings option 508. The electronic device's circuitry can be configured to present display 1000 of FIG. 10 in response to receiving a user selection of settings option 508. Display 1000 includes options region 1002, which includes options that the user can select and use to adjust, for example, audio recording-related parameters.

In response to the user selecting category option 1004, for example, the electronic device can present to the user categories display 1100 of FIG. 11. Categories display 1100 includes category options region 1102. Each category can be associated with, for example, different types of recording parameters, such as those discussed in connection with options region 1002. For example, an interview category can result in high quality recordings with automatic splits. Automatic splits or other modifications can occur at a predefined frequency (e.g., every hour, 20 minutes, 1 minute, etc.) and/or dynamically in response to predefined stimuli (e.g., silence for a predetermined period of time, vocalization of a particular word or phrase (when, e.g., voice recognition functionality is enabled), predefined movements, reception of wireless signal, change of physical location (as determined by, e.g., GPS locator, accelerometer, etc.), and/or any combination thereof). As another example, a podcast category can result in medium quality recordings with automatic splits every 10 minutes and automatic markers every 1 minute. In response to other option 1104 being selected, the electronic device can, for example, allow a user to create a new, user-specific category.

In addition, different categories may be associated with different modification options. For example, the interview category can be associated with “question” and “answer” modification options, which can be used to mark where questions and answers begin and end while conducting and recording an interview. As another example, the lecture category can be associated with “important” and “irrelevant” modification options, which a student can use to mark where important or irrelevant portions of a lecture begin and end. As yet another example, an audio book category can be associated with “chapter mark” modification options. In this manner, the electronic device is enabled to intelligently mark different types of audio recordings in a manner that is adaptive to how a user will probably want to refer to the portions of the recorded content at a later time.

Different categories and modification options can also allow other systems and devices to automatically determine, e.g., the general subject matter and importance of an audio recording. For example, an audio recording associated with the podcast category may be automatically published and syndicated to a web blog or other website by the electronic device, a host device and/or media server.

FIG. 12 includes display 1200 that may be displayed in response to the electronic device's power supply becoming depleted below a particular threshold. The user may choose to ignore the warning provided by display 1200 or cancel the recording to avoid risking the loss of at least a partial audio file.

The detailed description thus far has, to avoid overcomplicating the discussion, generally focused on and referenced media displays, media files, media file systems, etc. that are related to audio signals. One skilled in the art would appreciate that the present invention is not limited to audio-related displays, data files, etc. In fact, the present invention can be used in connection with any type of media (including, e.g., audio, video, still images, clip art, animation, other forms of moving images, any other type media and/or any combination thereof). Although the electronic device referenced herein can be any electronic device (as discussed above), additional technical challenges have been overcome to implement the present invention, including the following methods, with a portable and/or solid-state drive device.

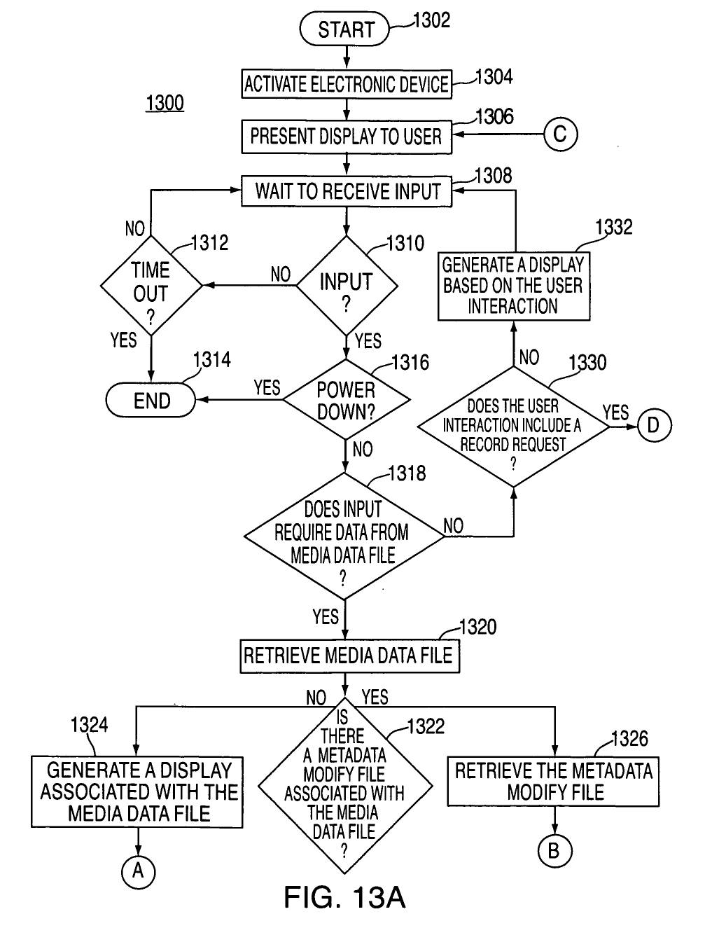

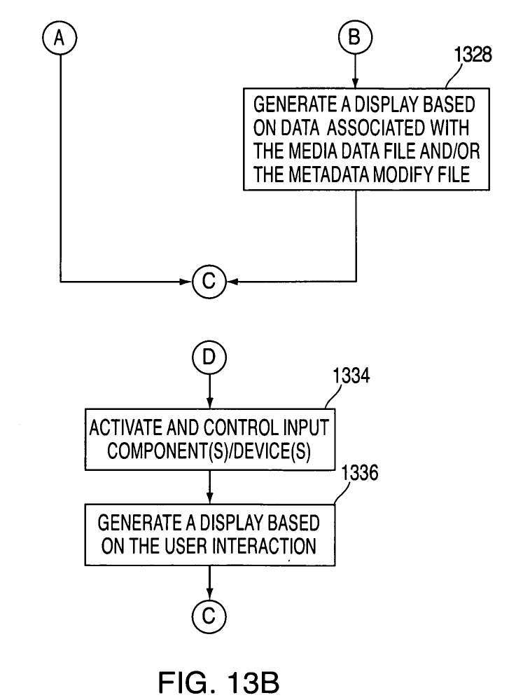

One embodiment for generating, accessing and modifying media data in accordance with the present invention is shown in process 1300 of FIGS. 13A-B. Process 1300 starts at step 1302 and at step 1304 the electronic device is activated (e.g., powered ON, exits stand-by mode, etc.) either automatically, in response to a user interaction, and/or in response to a command from a remote or host device. For example, the electronic device can be an iPod™ that is powered down until a user presses any button on its click wheel. As another example, the electronic device could be a cellular telephone and is activated in response to receiving a wireless signal from a cellular telephone tower.

After the electronic device is activated, the circuitry of the electronic device can present a display to the user at step 1306. The display initially presented can be generated from data stored in the electronic device's memory and/or storage.

At step 1308 the electronic device waits to receive an input, such as an indication of a user interaction from, for example, a user input or interface component or device. At step 1310, the electronic device determines whether or not its input circuitry has generated a command in response to receiving a user interaction or either input signal. When the electronic device has not received an input, process 1300 advances to step 1312.

To conserve power, the electronic device can be configured to automatically shut down, turn on a screen saver, enter a stand-by mode and/or perform any other function that will end process 1300. When, at step 1312, the electronic device determines that a predetermined amount of time has not elapsed and that the electronic device should continue to wait for an input, process 1300 returns to step 1308 and the electronic device continues to wait to receive an input. When the electronic device determines at step 1312 that it has timed-out, process 1300 ends at step 1314.

Returning to step 1310, in response to the electronic device receiving an input, the electronic device first determines whether the input caused a power down command to be generated. When the electronic device determines at step 1316 that the device should power down, process 1300 ends at step 1314. In response to the electronic device determining that the a power down command was not generated, process 1300 proceeds to step 1318.

At step 1318 the electronic device determines whether or not the input caused a command to be generated that includes accessing a media file stored on the electronic device. As used herein, the phrase “media file” includes any type of electronic file that contains media data, such as, for example, audio data, video data, image data, etc. Audio files can be formatted as, for example, *.m4p files, *.wav files, *.mp3 files, *.wma files, etc. Video files can be formatted as, for example, *.mov files, *.mpeg-2 files, *.mpeg-4 files, *.avi files, etc. Image files can be formatted as, for example, *.tiff files, *.raw files, *.jpg files, *.gif files, etc.

When the electronic device determines that it has to access a media file in response to the input, process 1300 proceeds to step 1320. At step 1320 the electronic device accesses the appropriate storage device (which may be a local or remote storage device) and retrieves the media file.

At step 1322, the electronic device determines whether there is a metadata modify file associated with the media file. In accordance with some embodiments of the present invention, virtual modifications that the electronic device makes to a media file are stored in a separate file, which is discussed above and referred to herein as a “metadata modify file.” The virtual modifications are stored as a type of metadata, and can be dynamic metadata. Media files can include pointers to any or all corresponding metadata modify files. Similarly, metadata modify files can include pointers to any or all corresponding media files.

Process 1300 advances to step 1324 in response to determining that there are no metadata modify files associated with the media file. At step 1324, the electronic device generates a display and, if necessary, can use the data in the media file. For example, the media file may include metadata, which are referred to herein as “static metadata.” Static metadata are bits of data that can be associated with media data and do not include executable commands. Static metadata may include, for example, title, artist, user rating, various user initiated tags (e.g., skip count, play count, etc.), date generated/downloaded, among others. Systems and methods for tagging media, locations and advertisements are discussed in commonly assigned U.S. Provisional Patent Application No. 60/923,439, filed Apr. 12, 2007, entitled TAGGING MEDIA, LOCATIONS AND ADVERTISEMENTS, which is incorporated herein by reference (client reference number P5059USP2). Examples of displays, which utilize static metadata from a media file, are display 800 of FIG. 8 (which includes media title) and display 900 of FIG. 9A (which includes the title while the audio is played back, both of which are derived from the media file). Process 1300 then returns to step 1306 and the display generated at step 1324 is presented to the user.

In response to determining at step 1322 that there are one or more metadata modify files associated with the user selected media file, process 1300 proceeds to step 1326. At step 1326, the electronic device retrieves the one or more metadata modify files.

Step 1328 follows step 1326. At step 1328, the electronic device generates a display and, if necessary, uses data from the media file and/or metadata modify file. Examples of displays that use metadata from both the media file and metadata modify file are display 906 of FIG. 9B and display 912 of FIG. 9C (both of which indicate that there are two virtual splits). The display generated at step 1328 can be presented to the user when process 1300 returns to step 1306.

Returning to step 1318, the electronic device can determine that, to respond to the input command(s), the electronic device does not have to access a media file, and process 1300 proceeds to step 1330. At step 1330, the electronic device determines whether or not the input caused a command to be generated that includes a record request. When the input did not cause the generation of a record request, process 1300 proceeds to step 1332. The electronic device generates a display at step 1332 that includes any changes required to respond to the input. For example, when the input was generated in response to a user moving a finger around a click wheel, the electronic device can generate a display in which the next item in the list is highlighted.

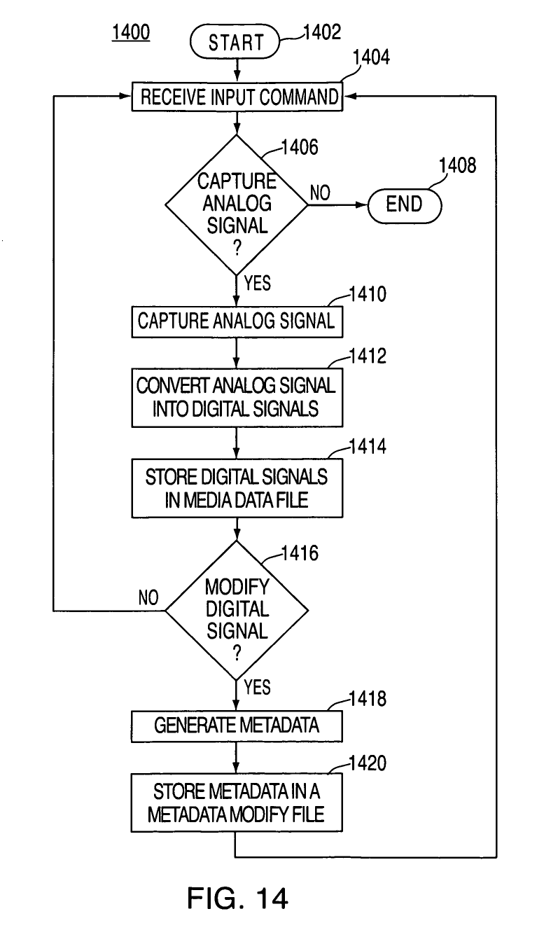

Returning to step 1330, the electronic device can determine that the input caused a record request to be generated. A record request could be generated in response to, for example, the user selecting start recording option 504 of FIG. 5. In response to the record request, at step 1334 the electronic device can activate and maintain control of one or more input components and/or devices, such as, e.g., a digital camera, video camera, microphone, any combination thereof, etc. Exemplary steps for maintaining control of the input component(s)/device(s) are discussed in connection with FIG. 14.

Process 1300 then proceeds to step 1336 and generates a display that reflects the system's response to the user interaction. The electronic device can, for example, generate a display similar to or the same as display 600 of FIG. 6A.

FIG. 14 shows process 1400, which includes exemplary steps for maintaining control of the input component(s)/device(s) in accordance with some embodiments of the present invention. Process 1400 starts at step 1402.

At step 1404, the electronic device receives a command generated by input circuitry in response to, e.g., a user interacting with the electronic device's user input or interface component, any other stimuli, and/or signal. The electronic device analyzes the command and determines at step 1406 whether or not the device should capture a particular analog signal. The analog signal may include light signals and/or audio signals. If, for example, the user does not want to capture an analog signal (e.g., the user selected pause option 608 of FIG. 6B while making an audio recording), the input device is disabled and process 1400 ends at step 1408. In addition to receiving a user indication to not capture or cease capturing an analog signal, the electronic device can also automatically determine that it should not capture an analog signal. For example, the electronic device can be configured to only capture an audio signal of a particular frequency (based on, e.g., a category setting), which ceases to exist.

When the electronic device determines at step 1406 to (in some instances, continue to) capture the analog signal, process 1400 proceeds to step 1410. For example, the electronic device determines at step 1406 that the user wants to capture the analog signal when the start recording option 504 is selected.

At step 1410, the electronic device captures the analog signals, converts each analog signal into one or more digital signals, and formats the digital signals as one or more media files.

The electronic device stores the digital media file(s) at step 1414 and determines at step 1416 whether the input is also associated with a modification command. A user selection of an editing option, such as those discussed above, can cause modification commands to be generated by various circuitry included in the electronic device. If the input did not cause a modification command to be generated, process 1400 returns to step 1404.

When the user interaction causes a modification command to be generated, process 1400 proceeds to step 1418. At step 1418, the electronic device generates metadata. The generated metadata can be a virtual modification that is stored in a metadata modify file at step 1420. Process 1400 then proceeds to step 1404.

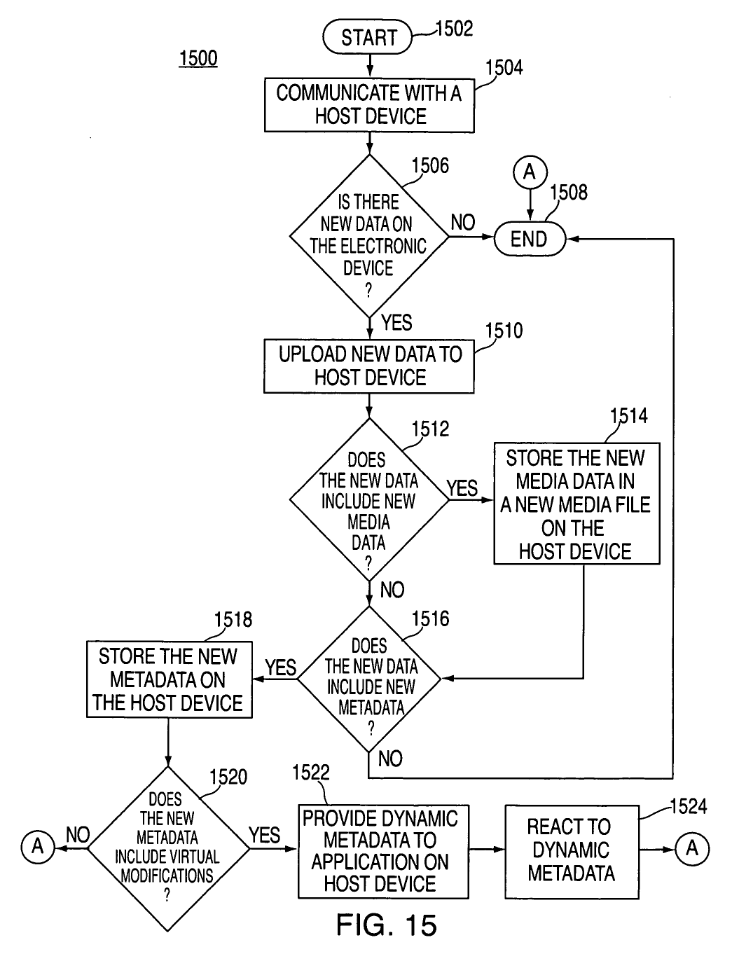

One embodiment for converting virtual modifications into actual modifications in accordance with the present invention is shown in process 1500 of FIG. 15. Process 1500 starts at step 1502, which can occur in response to the electronic device being coupled (either physically or wirelessly) to a host device. A host device can be any device or system that can receive data from the electronic device and convert virtual modifications to actual modifications. The host device can be, for example, one or more of a laptop or desktop computer, a network server (such as Apple's .MAC™ servers), and/or an accessory device. The host device can include or have access to an electronic file system and processor that is not stored on, maintained by or located within the electronic device (i.e., that is external to the electronic device).

At step 1504, the electronic device establishes a communications protocol and exchanges data with the host device. The host device can use the data received at step 1504 to determine at step 1506 whether or not there is new data on the electronic device. Whether data is new can be based on, for example, the last time the host device exchanged information with the electronic device and/or any delta between the data stored on the electronic device and host device. When there is no new data on the electronic device, process 1500 ends at step 1508.

When there is new data on the electronic device, the new data is uploaded from the electronic device to the host device at step 1510. The electronic device's communication circuitry can be used to facilitate the uploading of the data from its storage device(s) and memory.

The host device can then determine whether any of the new data is media data stored in a media data file. New media data can include, for example, locally-generated media data (such as audio, video or image data) that the electronic device generated. At step 1514, the new media data is stored on the host device and can be organized in accordance with the host device's media file system.

After step 1514 or when the new data does not include new media data, process 1500 advances to step 1516. At step 1516, the electronic device determines whether the new data includes new metadata. New metadata can include, for example, new dynamic metadata that the electronic device generated in response to, for example, the user selecting an editing option. New metadata can also include, for example, static metadata, which may be an update to a play count list (i.e., how many times has a song or movie been played).

When the new data does not include new metadata, process 1500 proceeds to step 1508 and ends. When the new data does include new metadata, process 1500 proceeds to step 1518 and the metadata is stored on the host device. At step 1520, the host device determines whether the new metadata includes virtual modifications (and/or any other dynamic metadata). Dynamic metadata can be, e.g., actively integrated into a display as a media file is being played back when the new metadata does not include virtual modifications, process 1500 proceeds to step 1508 and ends.

When the new metadata does include virtual modifications, the process proceeds to step 1522, at which the host device provides the dynamic metadata portions to, for example, an application running on the host device. The application running on the host device can be a media editing application (such as, e.g., Apple's iMovie™, iTunes™, GarageBand™, Apparature™, etc.) or any other application. The application can generate the proper command(s) in response to receiving the dynamic metadata. For example, when the applications determines that the dynamic metadata indicates that a media file is a podcast, iTunes™ can automatically publish and syndicate the podcast to web users. As another example, when the applications determines that the dynamic metadata includes a virtual split for an audio recording, GarageBand™ can automatically turn the virtual split into an actual split (i.e., split a single media file into a multi-part media file). Process 1500 then ends at step 1508. Systems and methods for synching data are discussed in commonly assigned U.S. patent application Ser. Nos. 11/770,641, filed Jun. 28, 2007, entitled “Separating Attachments Received from a Mobile Device” and 11/834,604, filed Aug. 6, 2007, entitled “Synching Data” (client docket no. P5436US1) which are incorporated herein in their entireties.

The processes discussed above are intended to be illustrative and not limiting. One skilled in the art would appreciate that steps of the processes discussed herein may be omitted, modified, combined, and/or rearranged, and any additional steps may be performed without departing from the scope of the invention.

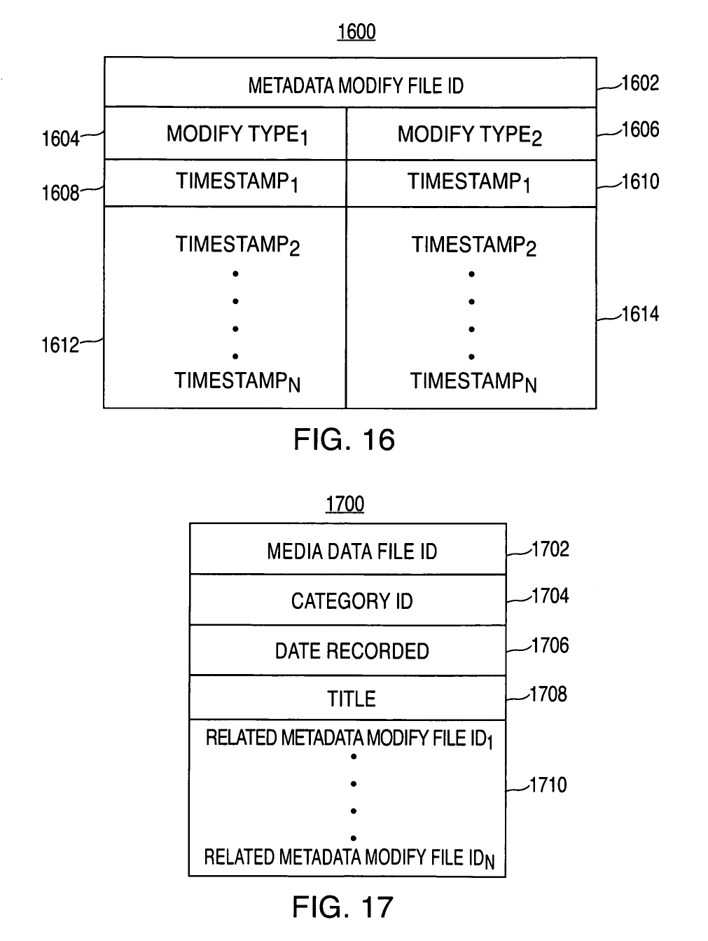

FIG. 16 shows an illustrative embodiment of metadata modify file 1600. Metadata modify file 1600 is a data structure that can be generated and maintained by, for example, an electronic device's operating system. Metadata modify file 1600 can be generated and updated in response to, for example, the user selecting an editing option, such as those discussed above.

Metadata modify file 1600 can include metadata modify file ID, which can be used to associate metadata modify file 1600 with (e.g., point to) a particular media file. Metadata modify file 1600 can also include one or more modify type fields. Each modify type field may indicate the type of modification associated with the timestamps stored in the other fields. Examples of different types of modifications include split, join, flag, move, delete and annotate. The annotate type field can be used to store supplementary media annotations (e.g., the user's voice) that is related to the media file. For example, during playback of an audio signal, the user can simultaneously record an audio message that is embedded in or linked to the audio file being played back. In some embodiments, there would be a primary audio track and a secondary annotation track. One skilled in the art would appreciate that an annotate modification could be used in connection with and/or be any type of media (e.g., text, audio, video, still image(s), etc.).

Metadata modify file 1600 includes two modify type fields, field 1604 and field 1606. Each modify field can be associated with one or more timestamp fields. Each timestamp field indicates when or where the virtual modification should be implemented when the associated media file is, e.g., played back by the handheld device and/or made permanent by a host device. Timestamp fields 1608 and 1612 are associated with field 1604 and timestamp fields 1610 and 1614 are associated with field 1606.

FIG. 17 shows an illustrative embodiment of media data structure 1700. Media data structure 1700 is a data structure that is associated with a media file, which contains media data. Media data structure 1700 can include static metadata associated with a media file.

Media data structure 1700 can include field 1702, which can include data that can be used to identify the particular media file that media data structure 1700 is associated with. In other embodiments, media data structure 1700 can be associated with multiple media files.

Fields 1704-1708 can include data that identifies, for example, the category, date recorded, and title of the media file identified in field 1702. Field 1710 can be used to associate the media data file identified in field 1702 with one or more metadata modify files, such as those discussed above.

The above disclosure is meant to be exemplary and not limiting only the claims that follow are meant to set bounds as to what the present invention includes.

What is claimed is:

1. A method of modifying an audio file using a handheld media device, comprising:
recording analog audio signals with the handheld media device, wherein the recording comprises:
generating an audio file with the handheld media device;
receiving the analog audio signals with the handheld media device;
converting the analog audio signals into digital audio data; and
storing the digital audio data in the audio file;
displaying an editing option;
in response to the editing option being selected, generating an edit command; and
in response to the edit command, generating metadata associated with the audio file, wherein the metadata is generated by the handheld media device.

2. The method of claim 1 further comprising:
storing the metadata as a virtual modification, wherein the virtual modification is stored in a metadata modify file that is separate from the audio file in the handheld media device.

3. The method of claim 2 further comprising:
accessing the audio file;
retrieving the digital audio data from the audio file;
determining that the audio file has been edited;
accessing the metadata modify file;
retrieving the metadata from the metadata modify file;
generating analog signals using the digital audio data;
emitting the analog signals to a user;
generating information using the metadata; and
presenting a display to the user, wherein the display includes the information.

4. The method of claim 2 further comprising:
uploading the audio file from the handheld media device to a host device;
uploading the metadata modify file from the handheld media device to the host device; and
receiving a modified audio file from the host device, wherein the modified audio file is derived from the digital audio data and the metadata.

5. The method of claim 1, wherein the generating the metadata comprises recording supplementary audio signals.

6. The method of claim 1, wherein the generating the metadata comprises generating a metadata tag.

7. The method of claim 1, wherein the generating the metadata occurs during a period of time that at least partially overlaps with the recording of the analog audio signals.

8. A method of modifying an audio file using a handheld media device, comprising:
playing back analog audio signals with the handheld media device, wherein the playing back comprises:
accessing an audio file with the handheld media device;
converting digital audio data stored in the audio file into the analog audio signals; and
emitting the analog audio signals;
displaying an editing option;
in response to the editing option being selected, generating an edit command; and
in response to the edit command, editing the audio file, wherein the editing comprises:
generating a virtual modification; and
storing the virtual modification in a metadata modify file that is separate from the audio file.

9. A method of modifying an audio file using a host device, comprising:
downloading the audio file on the host device;
storing the audio file on the host device;
downloading a metadata modify file on the host device;
storing the metadata modify file on the host device; and
generating a modified audio file, wherein the modified audio filed is the audio file as modified based on metadata included in the metadata modify file.

10. The method of claim 9 further comprising:
determining the metadata is dynamic metadata that causes the host device to automatically publish the audio file to a website; and
in response to the determining, uploading the modified audio file to a server; and
publishing the modified audio file on the website.

11. A handheld media system that modifies an audio file, comprising:
an input component that generates an input command;
a display component for displaying information to a user;
a microphone that receives analog audio signals;
a storage device that stores audio files; and
circuitry that is configured to:
convert the analog audio signals into digital audio data;
store the digital audio data in an audio file on the storage device;
generate metadata in response to receiving the input command;
associate the metadata with the audio file; and
store the metadata separately from the audio file.

12. The handheld media system of claim 11, wherein the input component is a click wheel.

13. The handheld media system of claim 11, wherein the storage device is a solid-state memory.

14. The handheld media system of claim 11, wherein the circuitry is further configured to:
generate a metadata modify file; and
store the metadata as a virtual modification in the metadata modify file, wherein the metadata modify file is stored separately from the audio file.

15. The handheld media system of claim 14, wherein the circuitry is further configured to:
access the audio file;
determine that the audio file has been edited;
access the metadata modify file;
retrieve the metadata from the metadata modify file;
generate analog signals using the digital audio data; and
generate the information using the metadata, wherein the information is presented on the display component; and further comprising:
at least one speaker that emits the analog signals.

16. The handheld media system of claim 14 further comprising:
a connector that electrically couples the handheld media device to a host device, wherein the circuitry is further configured to participate in the transfer of the metadata modify file and the audio file to the host device.

17. The handheld media system of claim 16, wherein the circuitry is further configured to:
receive the audio filed as modified by the host device; and
store the audio file as modified on the storage device.

18. The handheld media system of claim 16, wherein the connector is a 30-pin connector.

19. The handheld media system of claim 14 further comprising:
a wireless connector that electrically couples the handheld media device to a server, wherein the circuitry participates in the transfer of the metadata modify file and the audio file to the server.

20. The handheld media system of claim 11, wherein:
the information includes an editing option; and
the input command is generated in response to the editing option being selected.

21. The handheld media system of claim 11, wherein the system comprises:
a handheld media device; and
an accessory device, wherein the microphone is integrated into the accessory device.

22. A computer readable medium encoded with machine-readable instructions for use in modifying an audio file with a handheld device, the machine readable instructions comprising:
storing analog audio in a digital format on a storage device as an audio file;
generating a metadata modify file, wherein the metadata modify file maps virtual modifications to the audio file;
displaying the virtual modifications;
enabling a user to navigate among the virtual modifications;
receiving a selection of one of the virtual modifications; and
in response to receiving the selection, playing back the audio file from a point in the audio file that is mapped to by the one of the virtual modifications.

23. The machine readable instructions of claim 22 further comprising:
generating a virtual modification in response to receiving a user input.

24. The machine readable instructions of claim 22 further comprising:
generating a virtual modification in response to an automatically detected predetermined event.
